(19) United States
(12) Patent Application Publication
(10) Pub. No.: US 2003/0091048 A1
(43) Pub. Date: May 15, 2003

(54) Detection of ciphering parameter unsynchronization in a RLC entity

(76) Inventor: Sam Shiaw-Shiang Jiang, Hsingchu (TW)

Correspondence Address: KAO H. LU, 686 LAWSON AVE, HAVERTOWN, PA, 19083, US

(21) Appl. No.: 10/286,034

(22) Filed: Nov. 1, 2002

Related U.S. Application Data
(60) Provisional application No. 60/337,733, filed on Nov. 13, 2001.

(51) Int. Cl. H04L 12/28; H04J 3/06

(52) U.S. Cl. 370/392; 370/503

(57) ABSTRACT

This invention is a method and a system to improve the detection of an out of ciphering parameter synchronization of a communication linkage in a ciphering-deciphering wireless communication system. The sender fills the unused data fields of a data package before sending, and the receiver verifies the content of data fields and the particular pattern of the unused data field of a received data package for discrepancy. If the accumulated error count of the receiver exceeds a predetermined threshold, the receiver will invoke a resynchronization of this communication link between the sender and the receiver.

### CROSS REFERENCE APPLICATION

This application claims priority from U.S. Provisional Patent Application No. 60/337,733 filed on Nov. 13, 2001.

### BACKGROUND

Ciphering and deciphering sensitive transmitting data between User Equipment (UE) and Radio Network Controller (RNC) is one of the ways to protect the data integrity in a wireless communication system. For instance, the sensitive data includes user data, system commands, billing and other key information. The sender packs data into a PDU format. In fact, the sender ciphers most fields of a PDU before sending the PDU out, and the receiver has to decipher the received PDU to extract the data.

Moreover, to maintain communication synchronization between the sender (RNC or UE) and the receiver (UE or RNC) in a ciphering-deciphering wireless communication system, the sender and the receiver have to continuously pass essential key ciphering parameters between themselves to reach the goal. At least five (5) key parameters are identified in such a system: Ciphering Key (CK), the Ciphering Sequence Number (COUNT-C), the Radio Bearer Identifier (BEARER), the Direction Identifier (DIRECTION), and the length indicator (LENGTH). The LENGTH determines the length of the required keystream block. LENGTH shall affect only the length of the keystream block, not the actual bits in it.

Bases on the ISO open architecture and depend on the transmission modes, The ciphering and deciphering functions are performed at different layer. See FIGS. 1A & 1B. If the Radio Bearer is using a transparent Radio Link Control (RLC) (Transparent Mode (TM)), these functions are performed in the Medium Access Control sub-layer (MAC entity), while using a non-transparent RLC mode (either Acknowledged Mode (AM) or Un-acknowledged Mode (UM)), these functions are performed in the RLC sub-layer. The layers above MAC and RLC sub-layers (the Upper Layers) configure four of the five essential key ciphering parameters CK, BEARER, LENGTH and DIRECTION. The Upper Layers have monitoring mechanisms to track the synchronization of these four parameters.

On the other hand, COUNT-C contains two parts: the hyperframe number (RLC HFN) and RLC SN (sequence number). As shown in FIGS. 2A, 2B and 2C where various PDU structures are shown, in the modes of RLC UM and AM, RLC SN goes together with the PDU without ciphered so that there is no synchronization problem on it. However, the start values of the RLC HFNs (both uplink and downlink) are configured by the Upper Layer and the RLC HFNs are then maintained separately by UE and UTRAN. Thus, the RLC HFNs are prone to be unsynchronized.

In RLC AM, there is a RESET procedure to re-synchronize the HFN values. The reset procedure is initiated by over maximum number of re-transmissions of a PDU or a PDU discard command, or erroneous sequence number. After any of the initiating conditions, the Sender will initiate a reset procedure. Both the uplink HFN and downlink HFN will be synchronized and the proper de-ciphering function is recovered.

The user data and upper layer signalling commands are submitted to the RLC layer in the format of the RLC Service Data Units (SDUs). The RLC SDUs are segmented and/or concatenated into PDUs of a fixed length that are passed down to the layer beneath. The Length Indicator (LI), included in the PDUs that LIs refer to, is set to the number of octets between the end of the RLC header and up to and including the octet at the end of an RLC SDU segment. In other word, LI defines boundaries between RLC SDUs within PDUs. Different sizes of LI are used depending on the size of the PDUs transmitted. Many times, one fixed-size transmitting PDU may allocate more blank space than the actual transmitting data needed. Therefore, padding is used when bits of arbitrary values are filled in the extra blank space of the PDU to maintain the minimum valid size.

In addition, a few specific values have been assigned for the LI field with special meaning or are reserved for use of later release version. For example, as shown in FIG. 4A, in a 7-bit LI, five values have been predefined for this field. Each predefined value has its special meaning. The value “1111100” is used only in UM mode while the value “1111110” is used only in a AM type transmission. Meantime, for a 15-bit LI, six (6) specific values for this field have been predefined as indicated in FIG. 4B. For example, the value “1111111111111100” is used only in the UM transmission to indicate certain type frame structure. Meantime, the value “1111111111111110” is used in AMD transmission for specific frame structure. LI field, as part of a PDU, will be ciphered and deciphered where the received contents of the LI may not be consistent with the LI rules due to error during transmitting or ciphering-deciphering process.

When the LI discrepancy happened, the receiver will discard the PDU. In RLC AM, the discarded PDUs will be reported back to the Sender and the Sender will retransmit these PDUs with configured maximum number of times. If this LI discrepancy happens due to ciphering parameter unsynchronization, the PDUs will be retransmitted and discarded repeatedly until a reset procedure is initiated. However, in RLC UM, there is no receiving acknowledgement procedure.

The UMD PDUs with LI discrepancy to the LI rules will be discarded by the UM RLC entity. If LI discrepancy to the LI rules are not detected and erroneous LI values are interpreted by the Receiver due to ciphering parameter unsynchronization, the Receiver will interpret the UMD PDU data wrongly and deliver erroneous RLC Service Data Unit (SDUs) to the Upper Layers. Thus, if ciphering parameter is out of synchronization, the UM RLC entity will continue to either discard erroneous PDUs or deliver erroneous RLC Service Data Unit (SDUs) to Upper Layers until the Upper Layers find that the response messages always time out and that retransmission of the Upper Layers messages or data does not work. Eventually, the Upper Layers will disconnect the connection. The radio resource is wasted severely during this time interval.

### SUMMARY

This invention provides an improved method and system to detect an out of synchronization of a communication link in a ciphering-deciphering wireless communication system. The sender assigns particular pattern to the unused space of selected data fields of a data package before sending it out, and the receiver checks the particular pattern of the received data package and uses these verifying results to detect if a communication link is out of synchronisation.

### BRIEF DESCRIPTION OF THE DRAWINGS

Following drawings with reference numbers and exemplary embodiments are referenced for explanation purpose.

FIGS. 1A-1B illustrate the data flow within the ISO layers;

FIGS. 2A-2C illustrate various PDU structures;

FIG. 3 illustrates one logical flow chart of this invention;

FIGS. 4A-4B illustrate the possible valid assignments for different lengths of LENGTH INDICATORS;

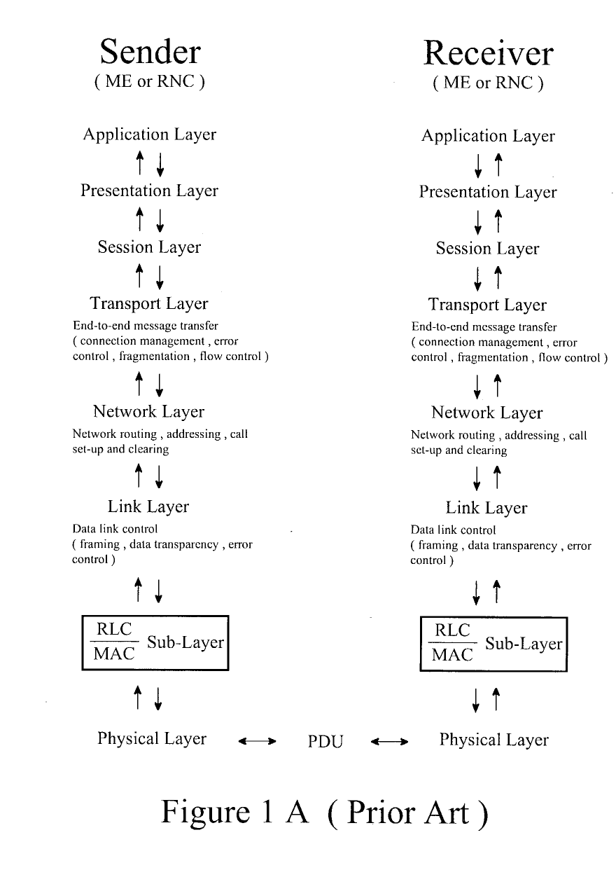

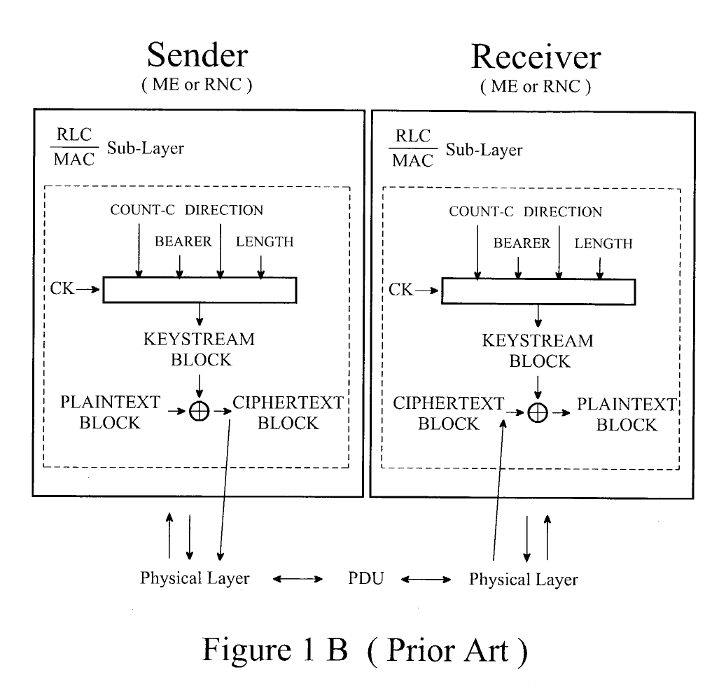

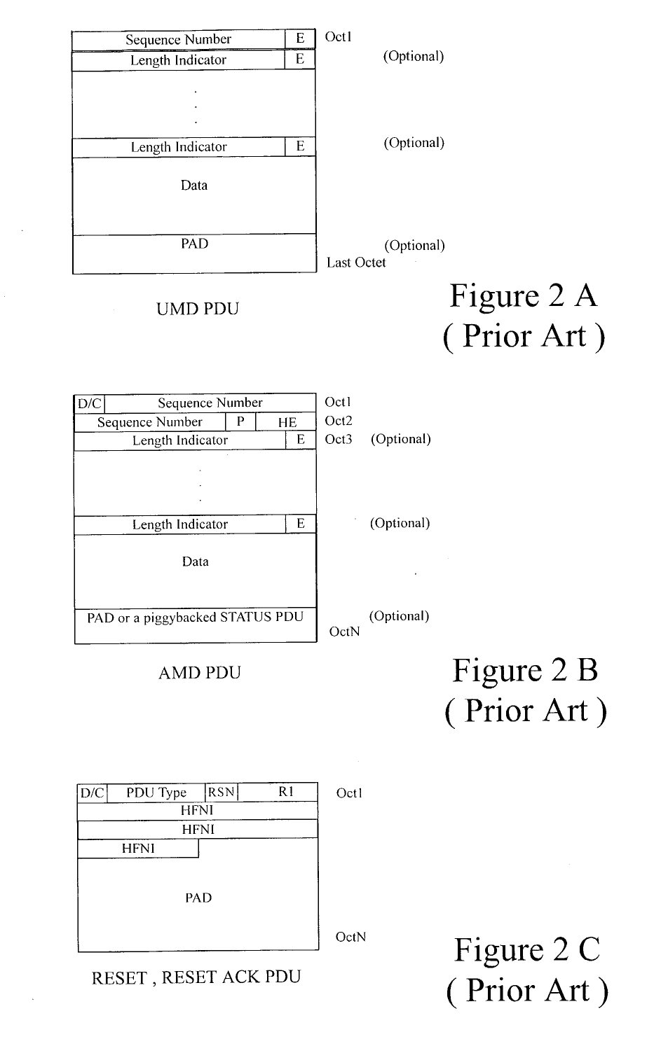

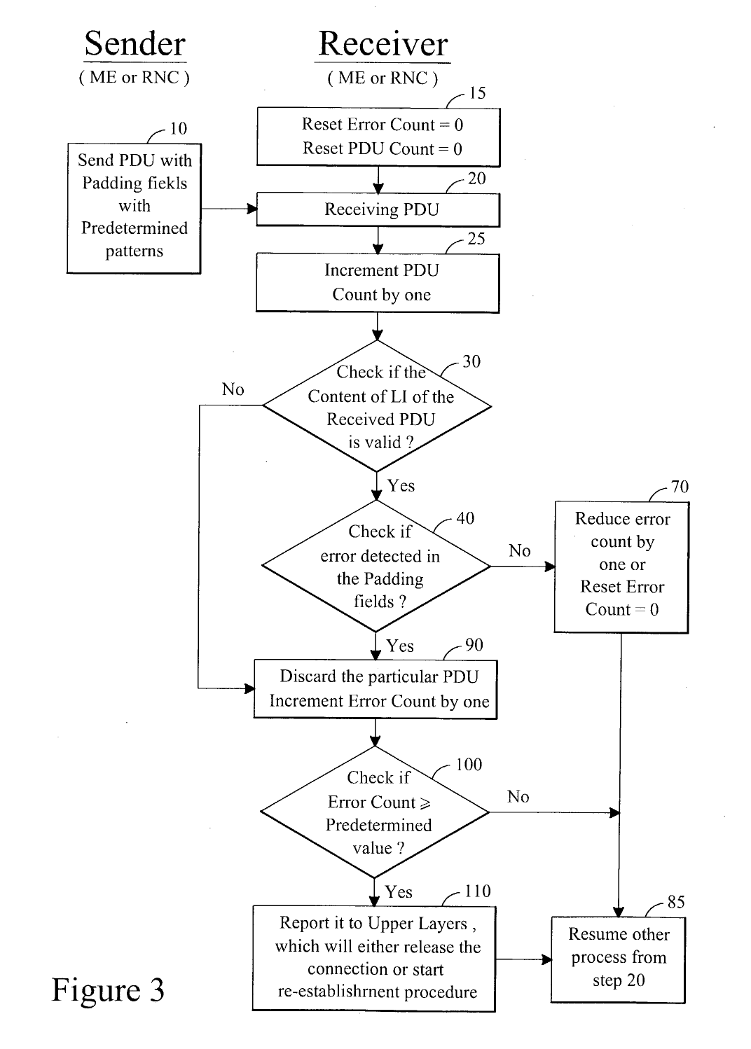

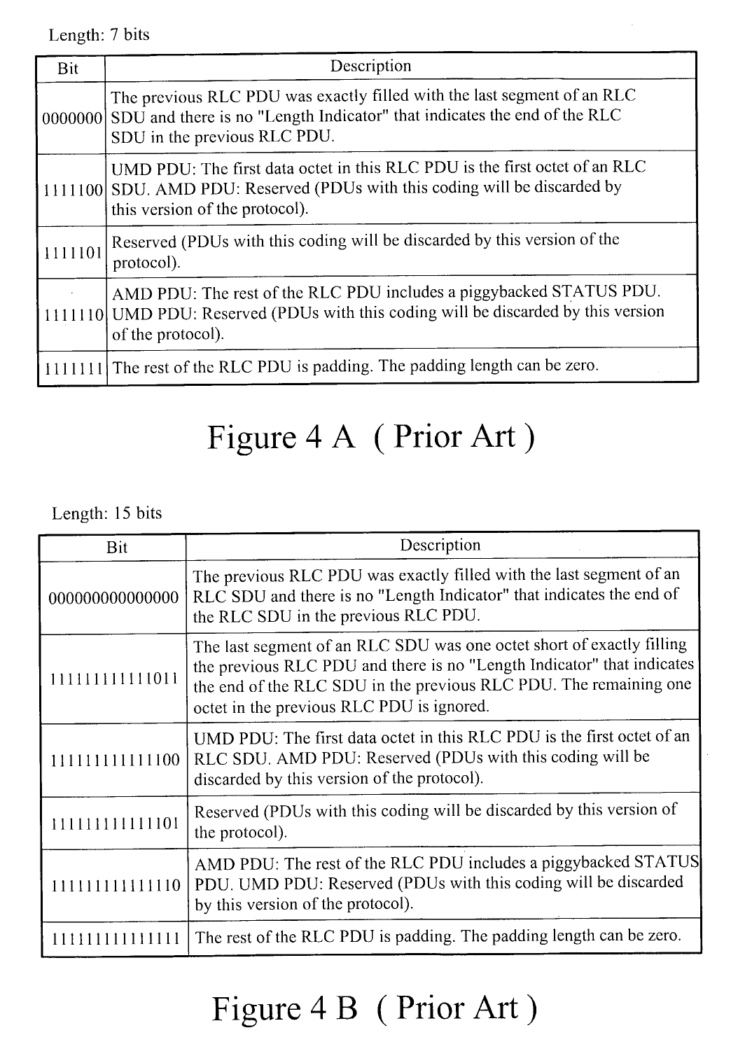

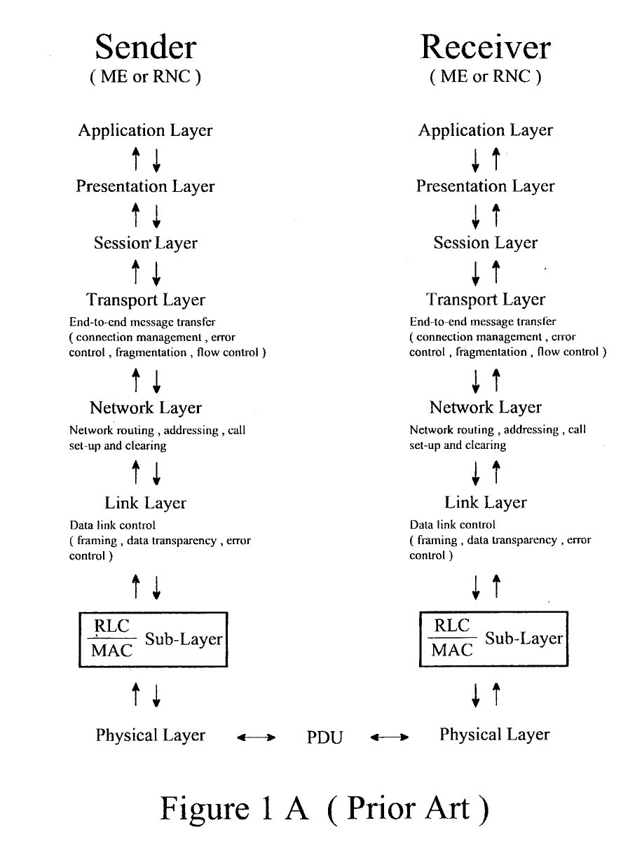

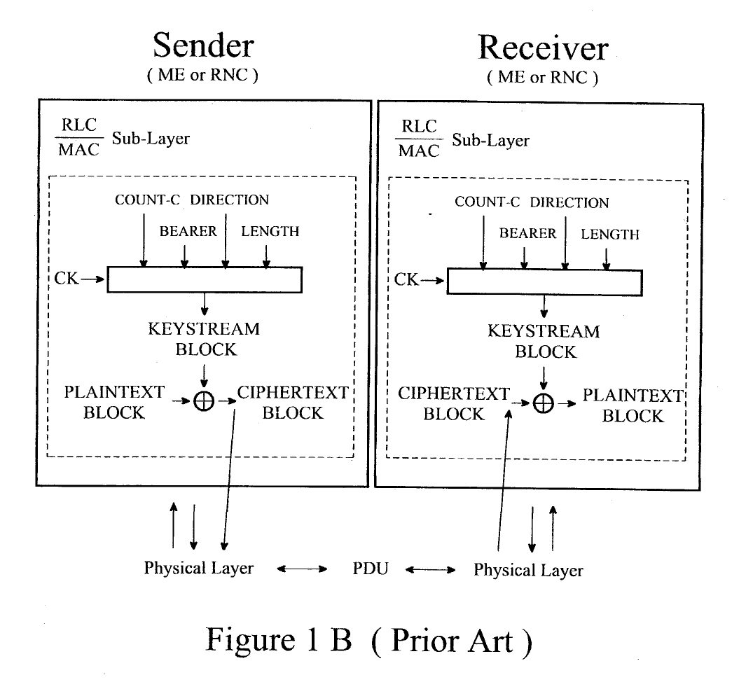

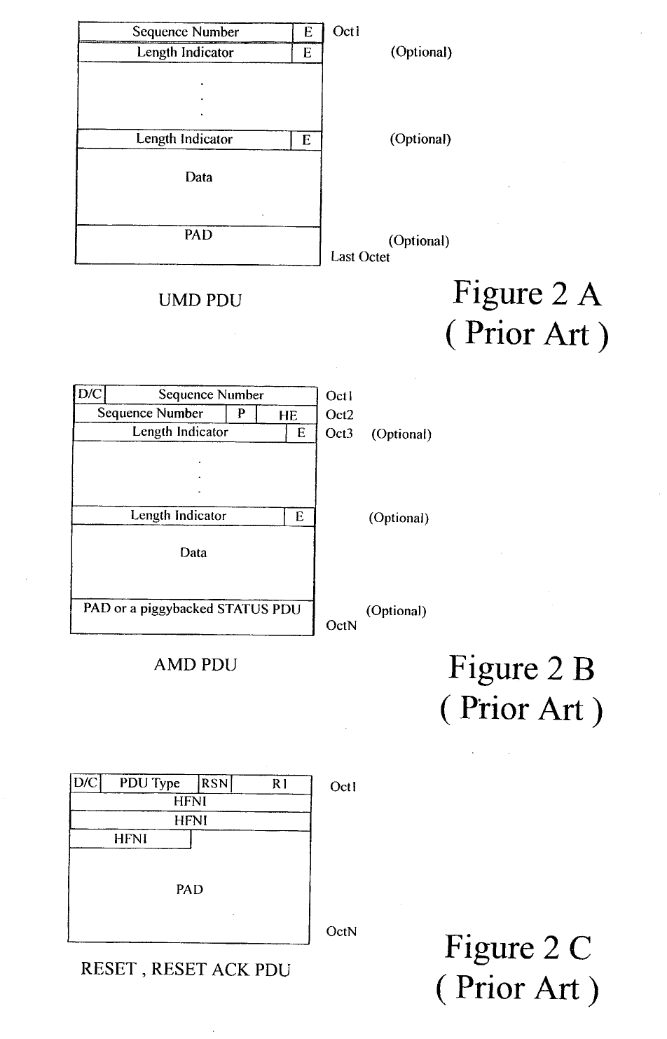

### DETAIL DESCRIPTION OF THE INVENTION

This invention adds more capacity to the system to check the synchronization of ciphering parameters between the sender and the receiver. As we have discussed, in a PDU, the data part is transparent to the RLC entity, but LI field and Padding are generated by some predefined rules in the Sender and interpreted in the Receiver by these rules. This invention is preferred to be applied on UM RLC entities. However, AM RLC entities are also applicable. In this invention, first, the receiver will check the validity of the received LI field.

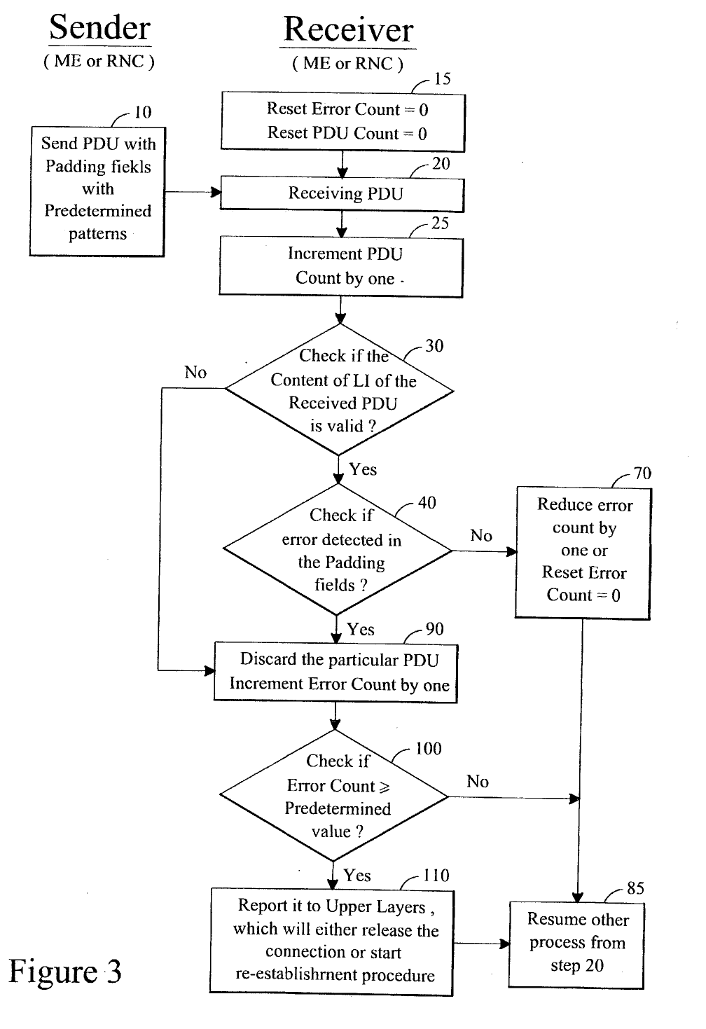

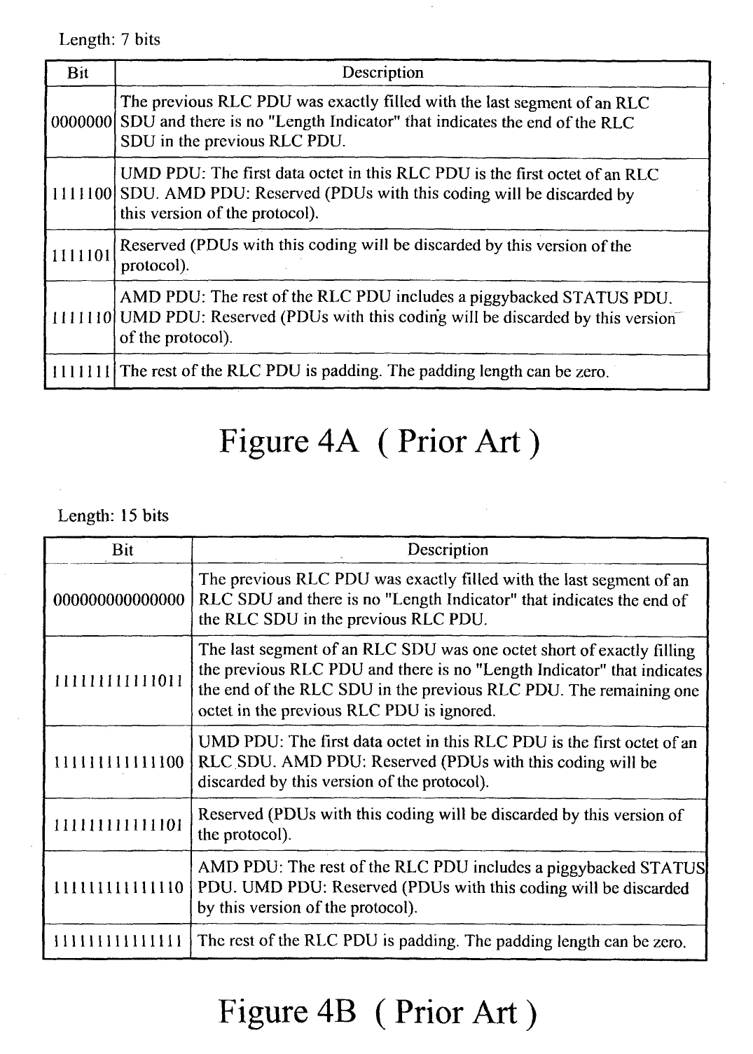

Because only a few limited number of rules are specified for the LI field, errors such as, LI numbers are out of correct order, value of the field is too large, or an AMD PDU-only LI value (a 7-bit LI of “1111110”) appearing in a UMD PDU, happened during transmission can be identified. Secondly, instead of filling arbitrary patterns in the Padding field of the sending PDUs, the sender will fill the sending Padding field with specified patterns, then the receiver can check if a transmission error happened by examining the content of the received Padding field against the predetermined pattern. If there is an invalid LI content or a discrepancy between the contents of the sending and received padding field, the Receiver can conclude with certain confidence that the ciphering parameters may have lost synchronization. Based on the above principle, an error detection method is developed, as shown in FIG. 3. When the sender (UE or RNC) sends its PDUs, instead of filling the Padding field with arbitrary patterns, the sender fills the field with predetermined patterns, e.g. all 0's, all 1's or 10101010 . . . etc. (step 10). Before the receiver receives any PDU, it resets Error Count and PDU Count to zero. (step 15) Once the receiver (UE or RNC) receives the PDU (step 20), it will increase PDU Count by one (step 20) and then check the deciphered LI field to see if a normal legitimate value is received (step 30). If the LI content has a valid value, the process goes to the step 40. Otherwise, it goes to the step 90. Next, in the step 40, the process will check the assigned patterns in the Padding field. If there is an inconsistency existing between the predetermined and the received patterns, in the step 90 the receiver will discards the PDU and increment the Error Count by one. In the next step (step 100), the process will check if the value of Error Count (EC) is equal to or exceeds a predetermined maximum error count (Max_EC). If EC>=Max_EC is true, the receiver reports the condition to the Upper Layers where either the receiver initializes a release of the communication connection or a re-establishment procedure for such connection (step 110). Then the process moves to step 85. Again refer back to the step 40, if no pattern inconsistency is found in these Padding fields between the predetermined and the received PDUs, the process goes to step 70. The receiver, in step 70, will decrement the Error Count by one unless Error Count has reached zero or reset the Error Count to zero if one or more than a predefined number of PDUs have been successfully received during the past interval without error. The process resumes to perform other operations in the next step (step 85).

There are many different ways to trigger the report of ciphering parameter unsynchronization in step 100 besides EC>=Max_EC. For example, one can use a percentage error count or the PDU Error Rate, which is defined to be the value of dividing the current Error Count (step 90) by the current PDU Count (step 25), which is the total number of received PDUs since the process started from step 15. The process should be resumed from step 15 when PDU Count achieves certain predetermined limit or when a timer of predetermined length expires. (This detail that the process resumes from step 15 is not shown in FIG. 3.) If such percentage error count value is greater than or equal to a predetermined value after certain amount of PDU Count, it indicates that the communication between the sender and the receiver has had severe error and a report of ciphering parameter unsynchronization is triggered.

The whole invention can be incorporated into the existing system through software, hardware or the combination of both.

What is claimed is:

1. A method for fast detecting an out of ciphering parameter synchronization of a communication linkage between stations in a ciphering-deciphering wireless communication system, having data transmitted in package format with a plurality of data fields, the receiving station (the receiver), receiving data packages sent by the sending station (the sender), using an error counter to track the number of the erroneous data packages received and an error result derived from the value of the error counter, wherein the method comprising:
the receiver receiving the data package from the sender;
the receiver verifying the content of the data fields of received data package and discarding the received data package if discrepancy existing;
the receiver adjusting the error counter and the error result based on the verification of each received data package;
if the error result exceeded a predetermined value, the receiver invoking a process to synchronize the communication link, starting a new cycle of checking and initiating the error counter.

2. The method of claim 1, the ciphering-deciphering wireless communication system is in an Acknowledge mode.

3. The method of claim 1, the ciphering-deciphering wireless communication system is in an Unacknowledge mode.

4. The method of claim 1, one of the data fields of the data package is the Length Indicator field.

5. The method of claim 1, adjusting the error counter further comprising the steps of
incrementing the error counter by one if a received data package is discarded because of content discrepancy of the data fields;
decreasing the error counter by one if the data fields of the received data package having right content while the value of the error counter is larger than zero.

6. The method of claim 5, wherein the error counter being set to zero if the data fields of the received data package having right content.

7. The method of claim 1, wherein setting the error result equal to the value of the error counter.

8. The method of claim 1, adjusting the error result further comprising the steps of:
setting the number of total received data packages to the total data counter; and
dividing the error counter by the total data counter to get the error result.

9. The method of claim 1, wherein the sender filling unused space of a data package with a selected pattern of a plurality of predetermined patterns before sending the data package out.

10. The method of claim 9, one of a plurality of predetermined patterns used to fill the unused space of the data package being with “0's”.

11. The method of claim 9, the unused space of the data package being one of the data fields of received data package and further comprising the steps of:
checking the validity of the unused space of the data package; and
checking the filled pattern of the unused space of received data package.

12. A system having means for fast detecting an out of ciphering parameter synchronization of a communication linkage between stations in a ciphering-deciphering wireless communication system, having data transmitted in package format with a plurality of data fields, the receiving station (the receiver), receiving data packages sent by the sending station (the sender), using an error data counter to track the number of the erroneous data packages received and an error result derived from the value of the error counter, wherein the receiver comprising:
means for receiving the data package from the sender;
means for verifying the content of the data fields of received data package;
means for discarding the receiving data package if discrepancy existing;
means for adjusting the error counter and the error result based on the verification of each received data package;
means for invoking a process to resynchronize the communication link, if the error result exceeded a predetermined value.

13. The system of claim 12, the ciphering-deciphering wireless communication system is in an Acknowledge mode.

14. The system of claim 12, the ciphering-deciphering wireless communication system is in an Unacknowledge mode.

15. The system of claim 12, one of the data fields of the data package is the Length Indicator field.

16. The system of claim 12, means for adjusting the error counter further comprising:
means for incrementing the error counter by one if a received data package is discarded because of content discrepancy of the data fields;
means for decreasing the error counter by one if the data fields of the received data package having right content while the value of the error counter is larger than zero.

17. The system of claim 16, wherein the receiver further comprising means for setting the error counter to zero if the data fields of the received data package having right content.

18. The system of claim 12, the receiver further comprising means for setting the error result equal to the value of the error counter.

19. The system of claim 12, means for adjusting the error result further comprising:
means for setting the number of total received data packages to the total data counter; and
means for dividing the error counter by the total data counter to get the error result.

20. The system of claim 12, wherein the sender further comprising means for filling unused space of a data package with a selected pattern of a plurality of predetermined patterns before sending the data package out.

21. The system of claim 20, one of a plurality of predetermined patterns used to fill the unused space of the data package being with “0's”.

22. The system of claim 20, the unused space of the data package being one of the data fields of received data package and further comprising:
means for checking the validity of the unused space of the data package; and
means for checking the filled pattern of the unused space of received data package.
